(19) United States
(12) Patent Application Publication
(10) Pub. No.: US 2010/0030826 A1
(43) Pub. Date: Feb. 4, 2010

(54) PRODUCTION-ALTERNATE SYSTEM INCLUDING PRODUCTION SYSTEM FOR PROCESSING TRANSACTIONS AND ALTERNATE SYSTEM AS A BACKUP SYSTEM OF THE PRODUCTION SYSTEM

(75) Inventors: Noriaki Kohno, Chiba (JP); Ritsuko Boh, Chiba (JP); Masaharu Murozumi, Chiba (JP)

Correspondence Address: HOFFMAN WARNICK LLC, 75 STATE ST, 14 FL, ALBANY, NY, 12207, US

(73) Assignee: INTERNATIONAL BUSINESS MACHINES CORPORATION, Armonk, NY (US)

(21) Appl. No.: 12/510,322

(22) Filed: Jul. 28, 2009

(30) Foreign Application Priority Data
Jul. 30, 2008 (JP) 2008-195777

(51) Int. Cl. G06F 17/30

(52) U.S. Cl. 707/204; 707/E17.005

(57) ABSTRACT

The present invention provides an alternate system as a backup system of a production system for processing transactions. The alternate system includes a restoring unit for obtaining, from a storage unit of the production system that stores data including at least one update regarding a transaction processed with the production system, the data including the at least one update at the last time the transaction was committed before a quiesce point to copy the obtained data to a storage unit in the alternate system, a copying unit for copying an update that is selected from a message queue that stores the update and information that is associated with each update and can identify the quiesce point, by using the information that can identify the quiesce point, and committed at the quiesce point or later, to the storage unit of the alternate system, and a transaction processing unit for taking at least one transaction from an accepting queue that accepts transaction processing upon completion of copying the selected update to start processing of the taken transaction.

### TECHNICAL FIELD

The present invention relates to a production-alternate system including a production system for processing transactions and an alternate system as a backup system of the production system, and to a method for switching transaction processing between the production system and the alternate system and a computer program product used therefor.

### BACKGROUND ART

Systems that operates continuously 24 hours a day, 365 days a year need to halt a production system and operate an alternate system for maintenance of hardware or software. For example, an alternate system in a banking system needs to take over data stored in a production system, for example, data about the balance on a user's account. In order to copy data in the production system to the alternate system while maintaining data consistency, however, it is necessary to halt the production system and then switch the production system to the alternate system. As a result, a service is suspended. To give an example of an existing technique of switching a production system to an alternate system without suspending a service, a method for concurrently operating the alternate system and the production system to continuously reflect production data on the alternate system is proposed. However, this method needs to adjust throughput of the alternate system to peak throughput of the production system and thus increases costs.

Japanese Unexamined Patent Application Publication No. 2006-268740 discloses a system and method suitable for shortening a time necessary for replication.

Japanese Unexamined Patent Application Publication No. 2005-538470 discloses a computer primary data storage system including an integrated storage system that integrates a file backup function and a remote replication function of the Invention

### SUMMARY OF THE INVENTION

A production-alternate system, in which an alternate system executes transaction processing in place of a production system, requires a measure for switching between a production system and an alternate system during maintenance of the production system without suspending transaction processing.

The present invention provides an alternate system that is a backup system of a production system for processing transactions.

In an embodiment, the alternate system includes: a restoring unit for obtaining, from a storage unit of the production system that stores data including at least one update regarding a transaction processed with the production system, data including the at least one update at the last time the transaction was committed before a quiesce point to copy the obtained data to a storage unit in the alternate system; a copying unit for copying an update that is selected from a message queue that stores the update and information that is associated with each update and can identify the quiesce point, by using the information that can identify the quiesce point, and committed at the quiesce point or later, to the storage unit of the alternate system; and a transaction processing unit for taking at least one transaction from an accepting queue that accepts a transaction processing request upon completion of copying the selected update to start processing of the taken transaction.

The information that can identify the quiesce point can be a timestamp related to the commit of the transaction or a relative byte address related to the commit of the transaction.

The data stored on the message queue can include a timestamp related to the commit of the transaction or a relative byte address related to the commit of the transaction.

The information that can identify the quiesce point can be obtained by executing a log suspend command or a backup system utility. The information that can identify the quiesce point can be obtained, for example, when the copying unit selects an update committed at the quiesce point or later.

Transmission of the update and the information that is associated with each update and can identify the quiesce point can be started before the quiesce point.

At the start of processing for acquiring the transaction, processing regarding the transaction transferred from the accepting queue to the production system has been entirely completed, is confirmed.

The storage unit of the alternate system further stores data including at least one update regarding a transaction processed with the transaction processing unit of the alternate system.

The system further includes a transmitting unit for transmitting to the production system, the data including the at least one update of the alternate system, from the storage unit of the alternate system, which stores an update regarding a transaction of the alternate system, at the last time the transaction was committed just before the quiesce point.

The system further includes a transmitting unit for transmitting to the message queue, at least one update regarding a transaction processed with the transaction processing unit of the alternate system, and information that is associated with each update and that can identify the quiesce point.

Further, the present invention provides a production-alternate system including: a production system for processing transactions; an alternate system that is a backup system of the production system; and an accepting queue for accepting a transaction, which is connectable to the production system or the alternate system.

The production system includes: a transaction processing unit for taking a transaction from the accepting queue and for processing the taken transaction; a storage unit for storing data including at least one update regarding a transaction processed with the production system; a first transmitting unit for transmitting to a message queue, the update and information that is associated with each update and that can identify a quiesce point; and a second transmitting unit for transmitting to the alternate system, the data including the at least one update, at the last time the transaction was committed before the quiesce point.

The alternate system includes: a storage unit of the alternate system for receiving data including the at least one update sent from the production system to store the received data; a copying unit for copying an update that is selected using the information that can identify the quiesce point and is committed at the quiesce point or later, from the message queue to the storage unit of the alternate system; and a transaction processing unit for taking at last one transaction from an accepting queue that accepts transaction processing requests upon completion of copying the selected update to start processing of the taken transaction.

The information that can identify the quiesce point can be a timestamp related to the commit of the transaction or a relative byte address related to the commit of the transaction.

The data stored on the message queue includes an update and a timestamp related to the commit of the transaction of the update or a relative byte address related to the commit of the transaction of the update.

The information that can identify the quiesce point can be obtained by executing a log suspend command or a backup system utility.

At the start of processing for acquiring the transaction, whether processing regarding the transaction transferred from the accepting queue to the production system has been entirely completed, is confirmed.

The storage unit of the alternate system further stores data including at least one update regarding a transaction processed with the transaction processing unit of the alternate system.

The system further includes a transmitting unit for transmitting to the production system, the data including the at least one update of the alternate system, from the storage unit of the alternate system, which stores an update regarding a transaction of the alternate system, at the last time the transaction was committed just before the quiesce point.

The system further includes a transmitting unit for transmitting to the message queue, at least one update regarding a transaction processed with the transaction processing unit of the alternate system, and information that is associated with each update and can identify the quiesce point.

Further, the present invention provides a method for switching transaction processing between a production system for processing transactions and an alternate system as a backup system of the production system.

The method includes: a step of obtaining, from a storage unit of the production system, which stores data including at least one update regarding a transaction processed with the production system, data including the at least one update, at the last time the transaction was committed before a quiesce point to copy the obtained data to a storage unit of the alternate system; a step of copying, from a message queue that stores the update and information that is associated with each update and that can identify the quiesce point, an update that is selected using the information that can identify the quiesce point and is committed at the quiesce point or later to the storage unit of the alternate system; and a step of taking at least one transaction from an accepting queue that accepts processing of the transaction upon completion of copying the selected update to start processing of the taken transaction, the steps being executed by the alternate system.

The method further includes a step of obtaining the information that can identify the quiesce point by executing a log suspend command or a backup system utility, the step being executed by the alternate system.

The information that can identify the quiesce point can be a timestamp related to the commit of the transaction or a relative byte address related to the commit of the transaction.

The method further includes a step of storing at least one update regarding a transaction processed with the alternate system in the storage unit of the alternate system, the step being executed by the alternate system.

The method further includes a step of storing in a message queue associated with the alternate system, at least one update regarding a transaction processed with the alternate system and information that is associated with each update and that can identify the quiesce point, in response to a command to switch the alternate system to the production system, the step being executed by the alternate system.

The method further includes a step of transmitting the data including the at least one update at the last time the transaction was committed before the quiesce point, from the storage unit of the alternate system to the production system, the step being executed by the alternate system.

The method further includes a step of transmitting an update selected using information that can identify the quiesce point and committed at the quiesce point or later, from a message queue associated with the alternate system to the production system, the step being executed by the alternate system.

The method further includes a step of switching transaction processing from the alternate system to the production system after all of the selected update is transmitted to the production system, the step being executed by the alternate system.

Further, the present invention provides a computer program product, which when executed by a computing system, switches switching transaction processing between a production system for processing transactions and an alternate system as a backup system of the production system. The computer program product causes the alternate system to execute the steps of the method according to any one of the above embodiment modes.

Further, the present invention provides a method for switching transaction processing between a production system for processing transactions and an alternate system as a backup system of the production system, in a production-alternate system including the production system, the alternate system, and an accepting queue for accepting a transaction, which is connectable to the production system or the alternate system.

The method includes: a step of taking a transaction from the accepting queue to process the taken transaction; a step of storing data including at least one update regarding a transaction processed with the production system in the storage unit of the production system; a step of transmitting to a message queue, the update and information that is associated with each update and can identify a quiesce point; a step of transmitting to the alternate system, the data including the at least one update at the last time the transaction was committed before the quiesce point, the steps being executed by the production system; a step of copying the data including the at least one update sent from the production system in a storage unit of the alternate system; a step of copying update that is selected using the information that can identify the quiesce point and is committed at the quiesce point or later, from a message queue to the storage unit of the alternate system; and a step of taking at least one transaction from the accepting queue that accepts transaction processing request upon completion of copying the selected update to start processing of the taken transaction, the steps being executed by the alternate system.

The method further includes a step of setting the quiesce point in response to a command to switch from the production system to the alternate system, the step being executed by the production system.

The step of transmitting the data including the at least one update at the last time to the alternate system can be performed at the start of transmission of the update and the information that is associated with each update and can identify quiesce point to the message queue.

The method further includes a step of stopping transmission of a transaction from the accepting queue to the production system before the completion of copying the selected update, the step being executed by a system for monitoring the accepting queue.

According to an embodiment mode of the present invention, the method further includes: a step of setting the quiesce point; a step of transmitting at least one update regarding a transaction processed with the alternate system and information that is associated with each update and can identify the quiesce point, to the message queue; and a step of transmitting at least one update regarding a transaction processed with the alternate system to the production system, the update being obtained at the last time when a transaction is committed before the quiesce point, the steps being executed by the alternate system in response to a command to switch the alternate system to the production system.

The method further includes: a step of storing the data including the at least one update transmitted from the alternate system in the storage unit of the production system; and a step of copying an update sent from the message queue to the storage unit of the production system, the steps being executed by the production system.

The method further includes a step of switching transaction processing from the alternate system to the production system after the selected update is sent to the production system, the step being executed by the alternate system.

According to embodiments of the present invention, it is possible to switch a production system to an alternate system only with several seconds of suspension of internal processing. The processing of the whole system is suspended only for several seconds. Further, a transaction is accepted during this suspension. Thus, it looks to an end user like the system is switched without suspension.

### BRIEF DESCRIPTION OF THE DRAWINGS

Various embodiments of the invention are described. However, these embodiments are described for illustrative purposes, and it is apparent to those skilled in the art that various modifications may be provided without departing from the technical scope of the present invention.

FIG. 1 shows an example of a system configuration according to an embodiment of the present invention.

FIG. 2 schematically shows a conventional method for switching a production system to an alternate system, and a method for switching a production system to an alternate system according to an embodiment of the present invention.

FIG. 3A shows an operation of a production system according to an embodiment of the present invention.

FIG. 3B shows the start of transmission of an update to an alternate system according to an embodiment of the present invention.

FIG. 3C shows the backup of a production system according to an embodiment of the present invention.

FIG. 3D shows the data structure of a log for storing information that is associated with an update and that can identify a quiesce point according to an embodiment of the present invention.

FIG. 3E shows the reflection of data to update a database in an alternate system according to an embodiment of the present invention.

FIG. 3F shows an example where an update committed at a quiesce point or later is selected and reflected according to an embodiment of the present invention.

FIG. 3G shows the switching of a production system to an alternate system according to an embodiment of the present invention.

FIG. 3H shows the halting of a production system according to an embodiment of the present invention.

FIG. 4A is a flowchart of processing for switching a system from a viewpoint of the alternate system according to an embodiment of the present invention.

FIG. 4B is a flowchart of processing executed in each of a production system and an alternate system according to an embodiment of the present invention.

### DETAILED DESCRIPTION OF THE INVENTION

The term “transaction” means an integrated one of one or more related processes. The transaction is, for example, a request from an end user or a command sent from a system. A result of processing the transaction is reflected on data managed with the system. This processing includes data update processing and commit of the transaction. The data update processing is, for example, “update”, “insert”, or “delete” executed in SQL. The commit of the transaction is, for example, “commit” executed in SQL. If the transaction is executed, the processing is executed. The processing ends in “complete failure” or “complete success” on a transaction basis. To enable “complete success”, the commit of the transaction should be successfully executed. For example, consider the execution of a transaction including data update processing 1, data update processing 2, and commit of the transaction. If the data update processing 1 succeeds but the data update processing 2 ends in failure, and the transaction is terminated without executing the commit of the transaction. In this case, the data update processing 1 is considered to have ended in failure. Therefore, data updated through the data update processing 1 is reverted to the original data. Further, if the data update processing 1 and the data update processing 2 succeed but the commit of the transaction ends in failure, and the transaction is terminated without executing the commit of the transaction. In this case, the data update processing 1 and the data update processing 2 are considered to have ended in failure. Accordingly, the data updated through the data update processing 1 and the data update processing 2 is reverted to the original data. In the above example, only when the data update processing 1 succeeds, the data update processing 2 succeeds, and the commit of the transaction succeeds, all of the processes of the transaction are considered to have succeeded and the data updated through the data update processes 1 and 2 is committed.

The term “production system” refers to a system for processing a transaction. The production system is operated under normal conditions.

The “alternate system” refers to a system for processing a transaction in place of the production system. The production system is replaced by the alternate system, for example, in the case where the production system halts for maintenance and the alternate system is operated during the maintenance, but the present invention is not limited to such a case. The maintenance can be performed at any time, for example. The maintenance is desirably performed during a time period that involves fewer transactions, in other words, at some time other than peak times. In this case, the alternate system only needs to have a throughput commensurate with processing of the production system at some time other than the peak times. Thus, a cost for the alternate system can be reduced. The alternate system desirably has a throughput equivalent to that of the production system during such an hour that involves fewer transactions, so as not to lower user service quality. For example, if the production system includes five central processing units (CPUs), and works with a throughput corresponding to two CPUs at a maintenance time, it is desirable to provide the alternate system with two CPUs. In this case, since the alternate system only needs to have a throughput equivalent to that of the production system during such an hour that involves fewer transactions, a cost for the alternate system can be reduced.

The term “update” refers to data obtained as a result of processing a transaction. The data is, for example, the balance on a user's account in a banking system, which is obtained as a result of processing a transaction as withdrawal.

The term “quiesce point” refers to a time point when data consistency is ensured between data before the execution of data backup. The backup data obtained through the backup includes an update resulting from a transaction already committed at the quiesce point and does not include an update resulting from a transaction not committed at the quiesce point. The backup data includes data obtained at the last time when a transaction is committed or later, before the quiesce point. The quiesce point is represented by a log relative byte address or time.

The quiesce point may be set in terms of log relative byte address or on a time scale (e.g., microsecond), by the production-alternate system or an administrator of the production-alternate system. The settings can be made on, for example, a utility that provides a function of restoring data from the backup.

The term “message queue” refers to a queue that stores the update and information that is associated with the update and that can identify the quiesce point. The term “queue” refers to one basic computer data structure. According to an embodiment of the present invention, the queue stores data in the form of a pushup list. As for the pushup list, at the time of taking data from the queue, the data is taken in a first-in first-out order.

The term “information that is associated with an update and can identify a quiesce point” means information usable only for determining a quiesce point out of the information obtained in the process of executing a transaction to obtain an update. The information includes, for example, a timestamp or relative byte address related to commit of the transaction. The information can be obtained by executing, for example, a log suspend command or backup system utility.

If the production-alternate system automatically sets a quiesce point, the administrator can preset the start time of transmission of an update and information that is associated with the update and can identify a quiesce point to a message queue. The start time of transmission can be set by the administrator entering the desired start time in a pop-up window displayed by the system, for example. The automatically set quiesce point is a later time than the maximum possible transaction processing time after the start time of transmission; this transaction processing time is set by the production-alternate system.

If the administrator sets the quiesce point by entering the point in a pop-up window displayed by the system, for example, the production-alternate system can automatically set the stat time of transmission of the update and the information to the message queue. The automatically set time is an earlier time than the maximum possible transaction processing time before the start time of transmission; this transaction processing time is set by the production-alternate system.

In the case of setting the quiesce point as well as the start time of transmission of the update and the information to the message queue by the administrator, the administrator can set the quiesce point and the time by entering these in a pop-up window displayed by the system, for example. In this example, an interval between the quiesce point and the start time is longer than the maximum possible transaction processing time, which is set by the production-alternate system.

The term “timestamp” refers to information representing the date and time when processing is executed. The processing is, for example, update processing, commit of the transaction, or executing a command to backup a database. However, the present invention is not limited thereto. The timestamp can be specified on a microsecond time scale. The time when the backup processing is executed is compared with the time when the other processing is executed to thereby identify the quiesce point.

The term “before quiesce point” refers to a time point when the last one of transactions committed before the quiesce point was committed.

The term “relative byte address” (RBA) refers to an address at which processing executed in the system can be stored. The address can be determined by the relationship with an address at which previous processing is stored. By following the addresses, the order in which the backup processing and the other processing can be executed can be determined to thereby determine the quiesce point.

The term “log suspend command” refers to a command to suspend the entire database processing with logging. The log can include, for example, a relative byte address, a timestamp, detailed processing and a processing result, and recovery information. However, the present invention is not limited thereto. The log suspend command can be used to confirm a relative byte address and timestamp during execution of a command and allow acquisition thereof. Thus, an update committed at a quiesce point or later can be selected from a message queue using this information.

The term “accepting queue” refers to a queue that stores transactions. The accepting queue can be on a system different from the production system and the alternate system. The accepting queue can be connected to, for example, a computer of an end user to store transactions sent from the end user. Further, the production system or the alternate system can be connected to the accepting queue. If the accepting queue is connected to the production system or the alternate system, the production system or alternate system can receive a transaction from the accepting queue.

Hereinafter, embodiments of the present invention will be described with reference to the accompanying drawings. The various embodiments are described for illustrative purposes and should not be construed as limiting the scope of the present invention. Throughout the drawings, identical reference numerals denote identical components unless otherwise specified.

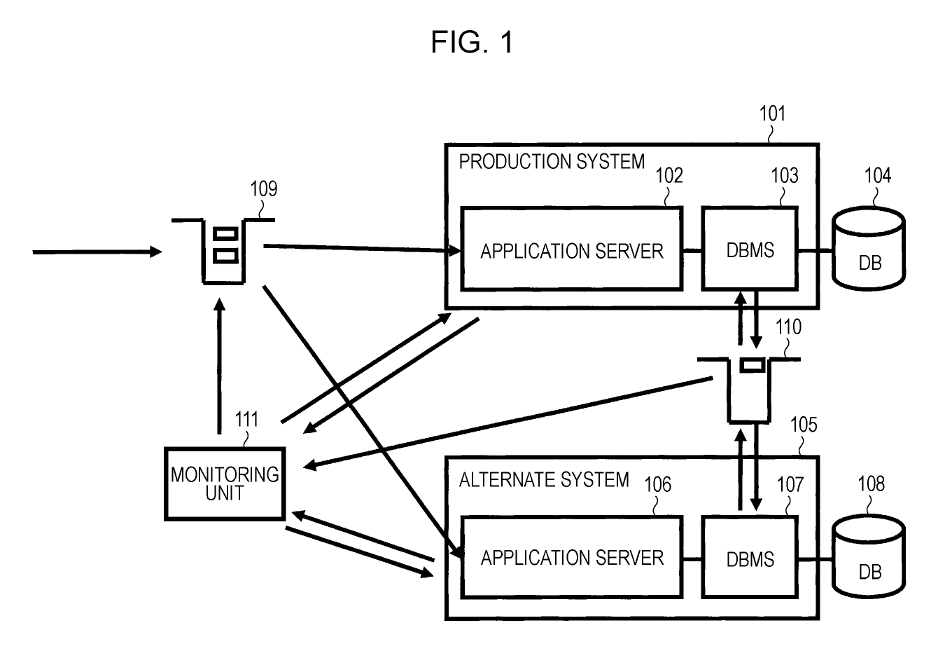

FIG. 1 shows an example of a system configuration according to an embodiment of the present invention.

A production system (101) is a system for processing a transaction under normal operations. An alternate system (105) is a system for processing a transaction in place of the production system (101), for example, when the production system (101) is suspended for maintenance. The alternate system (105) has the same transaction processing function as the production system (101). An accepting queue (109) stores transactions and sends the transactions to the production system (101) or the alternate system (105). The accepting queue (109) is on a system different from the production system (101) and the alternate system (105). The accepting queue (109) can accept a transaction even if the production system (101) and the alternate system (105) halt. The transactions are stored on the accepting queue (109) from a computer (not shown) of an end user. The production system (101) or the alternate system (105) receives a transaction from the accepting queue (109). Alternatively, a system for controlling the accepting queue (109) may send a transaction to the production system (101) or the alternate system (105). The transaction includes processing for updating data managed with the production system (101) or the alternate system (105). The transaction is processed with application servers (102, 106) as a transaction processing unit. Data including an update is recorded to storage units (104, 108). Restoring unit (103, 107) prepares and restores the data recorded to the storage units (104, 108). The storage units (104, 108) may be provided as a database. If the storage units (104, 108) are provided as a database, the restoring units (103, 107) may be configured as a database management system. Database management systems (103, 107) perform database control.

The system configuration for switching the production system (101) to the alternate system (105) is as follows. The restoring unit (103) of the production system (101) obtains an update from a transaction. The restoring unit (103) of the production system (101) generates information that is associated with each update and that can identify a quiesce point (hereinafter referred to as “information to be queued”). The restoring unit (103) of the production system (101) generates backup data of data including an update recorded to the storage unit (104) of the production system (101). The restoring unit (103) of the production system (101) generates information that can identify the quiesce point for the backup data. The information is included in the information to be queued or backup data.

The restoring unit (103) of the production system (101) may include a transmitting unit. The transmitting unit sends the log where the update and the information to be queued are written, to the message queue (110). In FIG. 1, the message queue (110) is shared between the production system (101) and the alternate system (105), but the message queue (110) may be included in the production system (101) or independently of the production system (101). The transmitting unit sends the backup to the alternate system (105). The backup data that is sent from the transmitting unit of the production system (101) to the alternate system (105) is acquired with the restoring unit (107) of the alternate system (105) and restored to the storage unit (108) of the alternate system (105).

The restoring units (103, 107) may include a copying unit. The copying unit of the alternate system (105) extracts the log where the update and the information to be queued are written, from the message queue (110). Alternatively, the copying unit of the production system (101) may extract the log where the update and the information to be queued are written, from the message queue (110). As a result of extracting the log, the log where the update and the information to be queued are written is deleted from the message queue (110). The copying unit selects an update using the information to be queued and the information that can identify the quiesce point for the backup data. The copying unit of the alternate system (105) copies the selected update to the storage unit (108) of the alternate system (105).

A monitoring unit (111) monitors the message queue (110). The monitoring unit (111) sends a command to stop a transaction to the application server (102) of the production system (101) according as almost all updates are deleted from the message queue (110). In response to the command, the application server (102) of the production system (101) stops receiving a transaction. Further, the monitoring unit (111) may send a command to stop a transaction to the accepting queue (109) according as almost all updates are deleted from the message queue (110). In response to the command, the accepting queue (109) stops transmitting a transaction. The monitoring unit (111) allows the application server (106) of the alternate system (105) to start receiving a transaction according as updates are deleted from the message queue (110).

The updates in the message queue (110) include updates corresponding to all transactions executed by the production system (101). In response to the command, the application server (106) of the alternate system (105) starts receiving a transaction from the accepting queue (109). Further, the monitoring unit (111) may send a command to switch a transaction to the accepting queue (109) according as updates are deleted from the message queue (110). In response to the command, the accepting queue (109) starts transmitting a transaction to the alternate system (105).

The system configuration for switching the alternate system (105) to the production system (101) is as follows. The restoring unit (107) of the alternate system (105) obtains an update through the transaction. The restoring unit (107) of the alternate system (105) generates the information to be queued. The restoring unit (107) of the alternate system (105) generates backup data of data including an update recorded to the storage unit (108) of the alternate system (105). The restoring unit (107) of the alternate system (105) generates information that can identify a quiesce point for the backup data. The information is included in the information to be queued or the backup data.

The restoring unit (107) of the alternate system (105) may include a transmitting unit. The transmitting unit sends the log where the update and the information to be queued are written to the message queue (110). The transmitting unit sends the backup data to the production system (101).

In FIG. 1, the message queue (110) is shared between the production system and the alternate system. However, the message queue (110) may be included in the alternate system (105) or independently of the alternate system (105). The backup data transmitted from the transmitting unit of the alternate system (105) to the production system (101) is received with the restoring unit (103) of the production system (101) and restored to the storage unit (104) of the production system (101).

The restoring units (103, 107) may include a copying unit. The copying unit of the production system (101) obtains the log where the update and the information to be queued are written from the message queue (110). Alternatively, the copying unit of the alternate system (105) may extract the log where the update and the information to be queued are written from the message queue (110). As a result of extracting the log, the log where the update and the information to be queued are written is deleted from the message queue (110). The copying unit selects an update using the information to be queued and the information that can identify a quiesce point for the backup data. The copying unit of the production system (101) copies the selected update to the storage unit (104) of the production system (101).

The monitoring unit (111) monitors the message queue (110). The monitoring unit (111) sends a command to stop a transaction to the application server (106) of the alternate system (105) according as almost all updates are deleted from the message queue (110). In response to the command, the application server (106) of the alternate system (105) stops receiving a transaction. Further, the monitoring unit may send a command to stop a transaction to the accepting queue (109) according as almost all updates are deleted from the message queue (110). In response to the command, the accepting queue (109) stops transmitting a transaction. The monitoring unit (111) allows the application server (102) of the production system (101) to start receiving a transaction according as updates are deleted from the message queue (110). The updates in the message queue (110) include updates corresponding to all transactions executed by the alternate system (105). In response to the command, the application server (102) of the production system (101) starts receiving a transaction from the accepting queue (109). Further, the monitoring unit (111) may send a command to switch a transaction to the accepting queue (109) according as updates are deleted from the message queue (110). In response to the command, the accepting queue (109) starts sending a transaction to the production system (105).

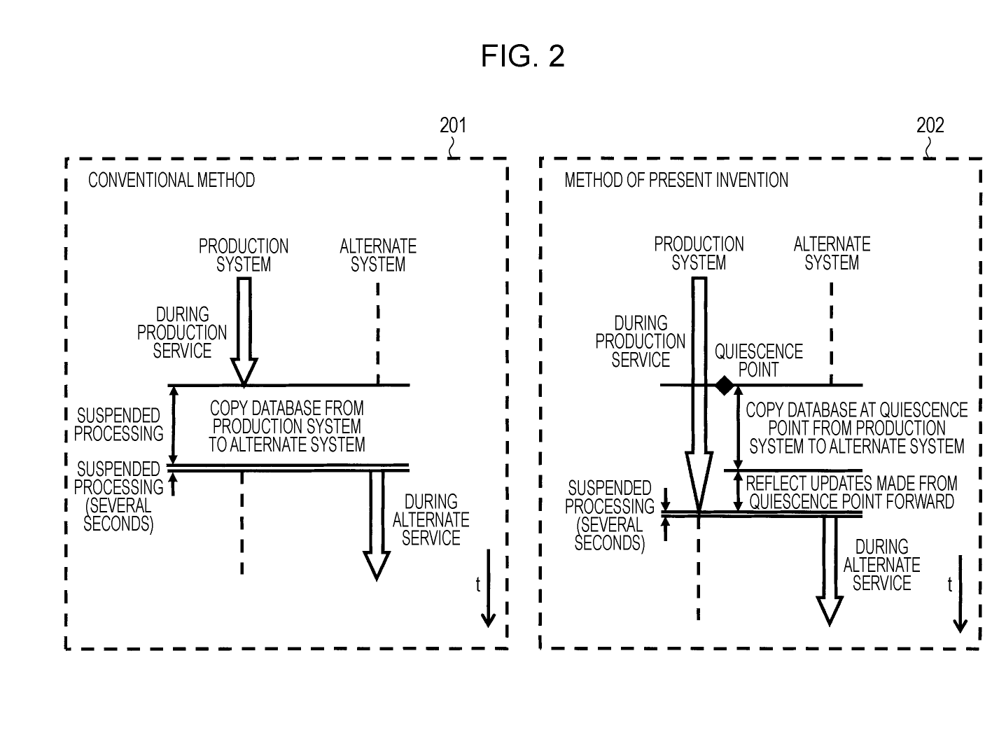

FIG. 2 schematically shows a conventional method for switching a production system to an alternate system, and a method for switching a production system to an alternate system according to an embodiment of the present invention.

According to the conventional method, the production-alternate system stops system processing during an operation of copying a database from the production system to the alternate system and an operation of switching the system. On the other hand, according to an embodiment of the present invention, the production-alternate system stops system processing only for a short time during a period corresponding to the processing for copying the database. The system processing is stopped only for several seconds necessary to switch the system. Accordingly, the method of this embodiment can considerably shorten a system suspension time compared with the conventional method. Further, in an embodiment of the present invention, an accepting queue that accepts transactions is prepared to accept transactions even during the system suspension. Thus, it appears that the transaction processing is executed without suspension.

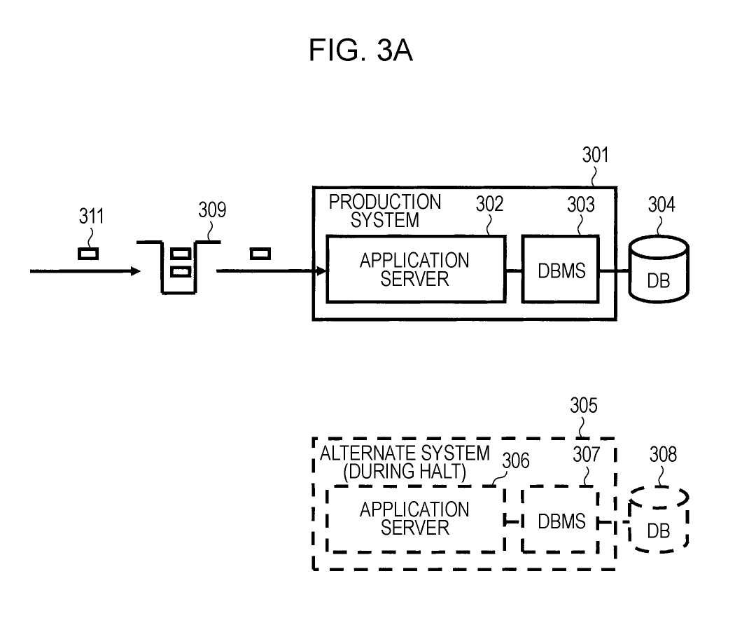

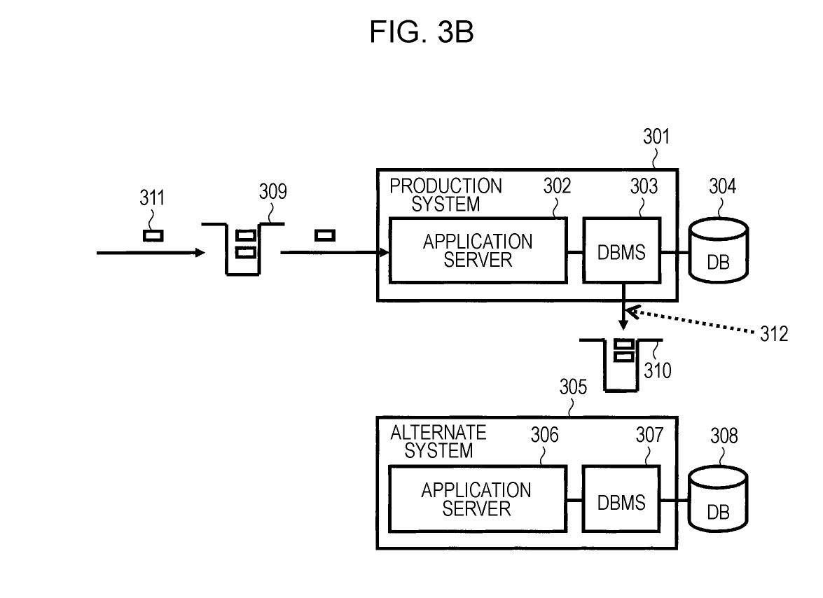

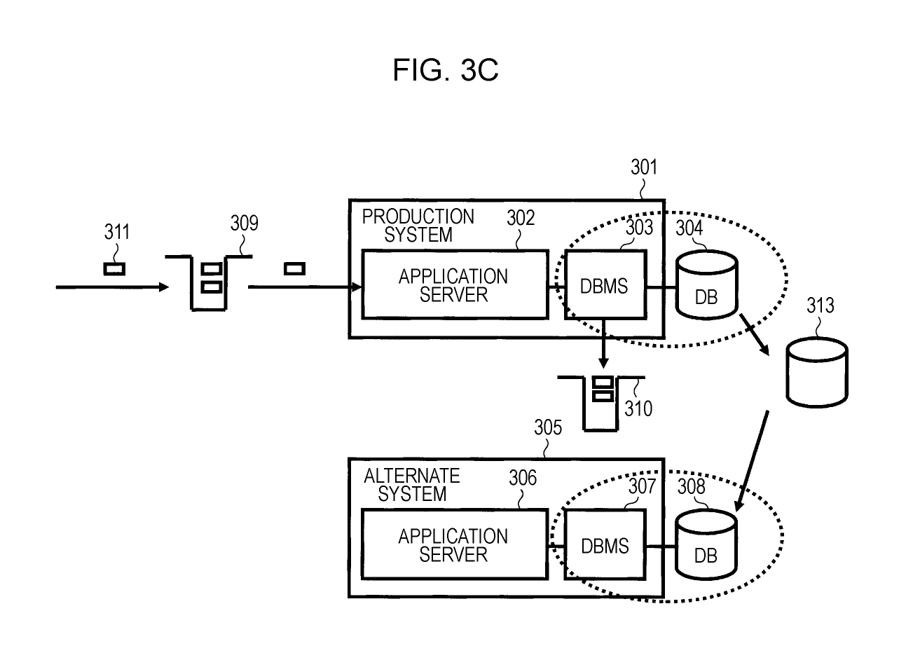

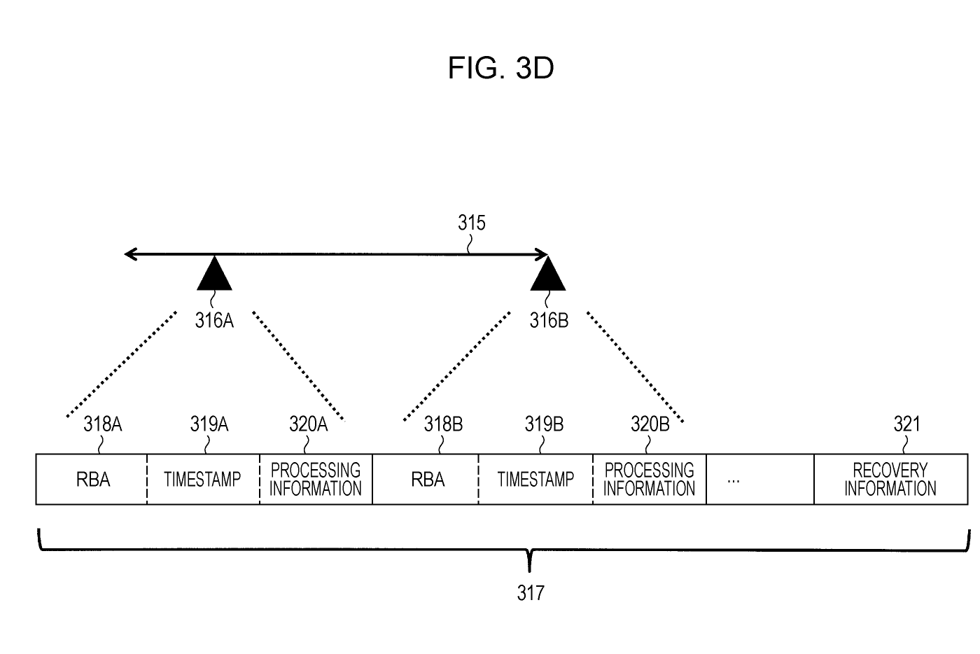

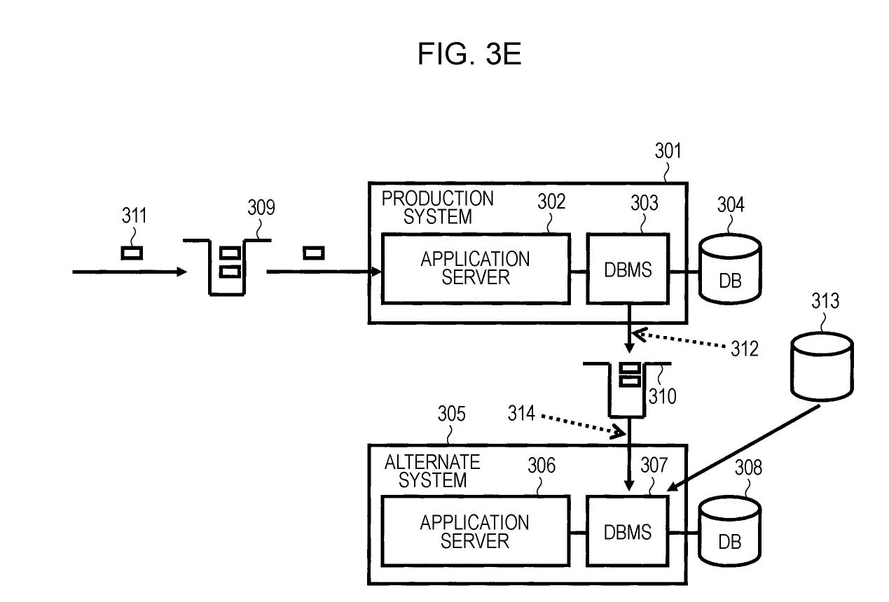

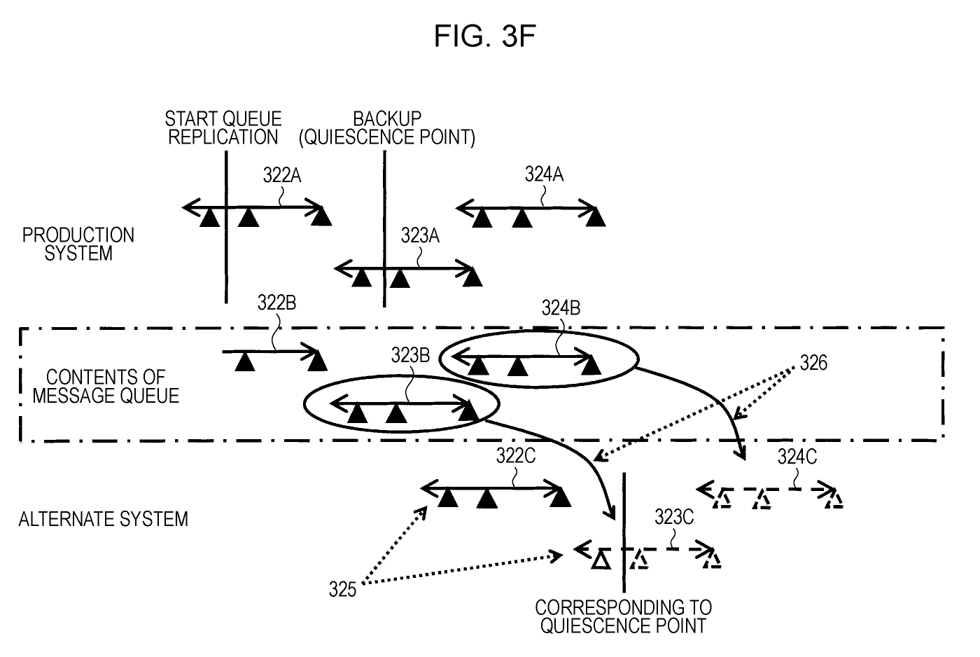

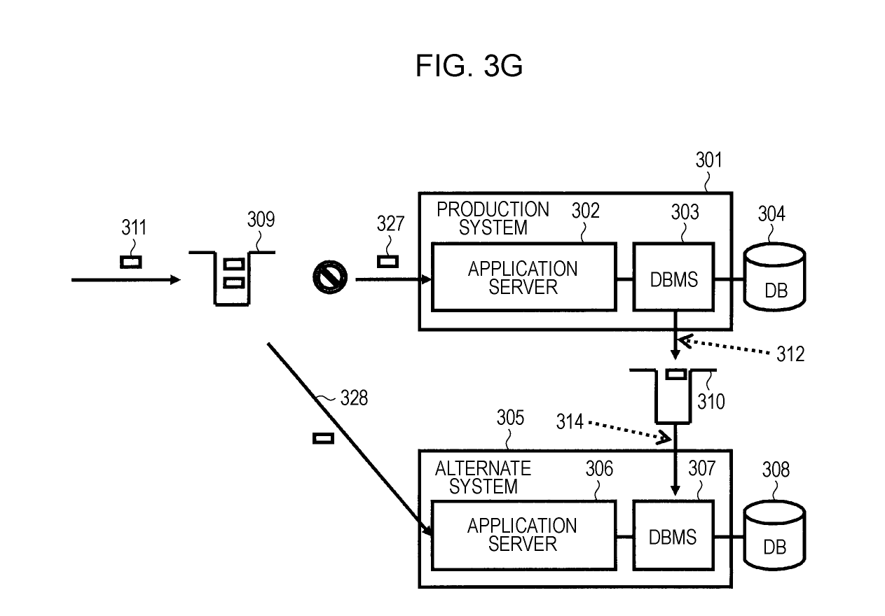

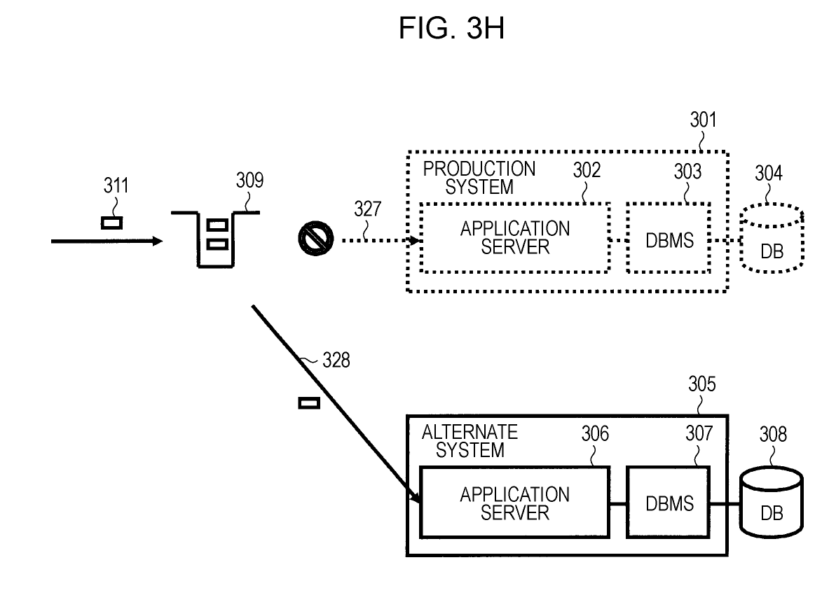

FIG. 3A shows an operation of the production system according to an embodiment of the present invention.

A transaction (311) entered by a user is placed into a accepting queue (309). The accepting queue (309) sends the transaction (311) to a production system (301). The production system (301) receives the transaction (311) from the accepting queue (309). The production system (301) processes the received transaction (311). The production system (301) commits the transaction (311) to thereby commit the processing. The processing result is reflected on the database (304). Here, the alternate system (305) is halted.

FIG. 3B shows the start of transmission of an update to the alternate system according to an embodiment of the present invention.

The production system (301) starts transmission (312) of an update to the message queue (310) through queue replication. Here, the update includes an update regarding a transaction and a log where information to be placed into the message queue (310) is written. The queue replication is a utility that sends an update of a database to the message queue to thereby reflect an update of a database in one system on another system. The queue replication is put on the market under a trade name of IBM WebSphere Replication Server, for example.

An administrator starts the alternate system (305) to connect the message queue to the alternate system. Here, at the start of transmission (312) of an update to the message queue (310), the alternate system (305) has not yet started an operation of reflecting the update (not shown), which was made through the queue replication. Further, the production system (301) has not yet stopped operations.

FIG. 3C shows how to backup the production system according to an embodiment of the present invention.

The production system (301) obtains backup data (313) of a database of the production system by using a backup utility. The backup utility obtains backup data at a time without stopping an updating operation of the production system. It is preferred to obtain the backup data at high speeds. Examples of the backup utility include a system backup utility that is put on the market under a trade name of IBM DB2. The DB2 refers to a relational database management system product and related product group available from IBM Corporation. The backup system utility can copy the whole database system at high speeds in combination with a high-speed copying function of an ESS as the IBM disk subsystem, which is called flashcopy. The database system can be completely copied in several seconds based on flashcopy.

The production system (301) can continue processing even during the operation of obtaining the backup data (313) of the database by use of the backup utility. The obtained backup data (313) include an update corresponding to a transaction already committed at the quiesce point, not an update corresponding to a transaction uncommitted at the quiesce point. At the time of obtaining the backup data (313), the production system (301) registers a quiesce point at which the backup data is obtained in the log where the information to be queued is written, together with a timestamp regarding the quiesce point or a relative byte address regarding the quiesce point. The registration is alternatively performed on a data set managed with the database management system (DBMS) (303) and the data may be included in the backup data (313). The data set may have the same format as the log where the information to be queued is written. The quiesce point, and the timestamp or relative byte address regarding the quiesce point are determined by executing a log suspend command or backup system utility, and the production system (301) can obtain the determined quiesce point and the determined timestamp or relative byte address regarding the quiesce point.

Although the backup system utility is used to obtain backup data, information about the quiesce point can be obtained in addition to the backup data by executing the backup system utility. The production system (301) starts receiving the backup data (313) several minutes after the queue replication. The time when the production system (301) starts receiving the backup data (313) is set to such a time that a queue replication is started before the start of a transaction that would be processed at the time of obtaining the backup data (313). To give an example thereof, the production system (301) obtains the backup data (313) after a given period from the start of the queue replication; the period is longer than the maximum possible transaction processing time that is set by the system. For example, in the production system (301) set to cancel a transaction if the transaction cannot be completed within 600 seconds, the system tries to obtain the backup data (313) after more than 600 seconds from the start of the queue replication. More specifically, the production system (301) tries to obtain the backup data (313) 601 seconds from the start of the queue replication. With this operation, transactions started before the queue replication have been entirely completed before an operation of obtaining the backup data (313), so processing for obtaining the backup data (313) can be automatically performed. The production system (301) does not stop operations during the operation of obtaining the backup data based on the backup utility.

The alternate system (305) obtains the backup data (313) by copying the data in the production system (301). As a result of copying the data, the backup data (313) is restored to be usable with the alternate system (305). For example, the alternate system (305) recovers a database storing data including an update made at the last time when a transaction is committed before the quiesce point, from the backup data (313) by using a restoring utility that can restore a database. The restoring utility is, for example, a restore system utility, which is put on the market under a trade name of IBM DB2. The restore system utility is to restore a DB2 system or database from the backup data obtained with the backup system utility.

FIG. 3D shows the data structure of a log for storing information that is associated with an update and that can identify a quiesce point according to an embodiment of the present invention.

A log (317) can be configured by repeating three data items, a relative byte address (RBA), a timestamp, and processing information as indicated by areas (318A to 320A) and areas (318B to 320B). Further, the log (317) may include recovery information (321). The recovery information (321) may include, for example, an address at which a restored database is stored and a time necessary to restore a database in the alternate system.

An output example of the log (317) regarding the transaction (315) is given below. The transaction (315) is composed of update processing (316A) and commit of the transaction (316B). When the transaction (315) starts, the update processing (316A) is first executed. A relative byte address where the executed update processing (316A) is stored is written to the area (318A) of the log (317). A timestamp as the execution time of the executed update processing (316A) is written to the area (319A) of the log (317). The time is, for example, the start time and end time of the update processing (316A). Processing information of the executed update processing (316A) is written to the area (320A) of the log (317). The processing information is, for example, an SQL statement corresponding to the update processing (316A) or an update corresponding to the update processing (316A).

Next, the update processing (316B) is executed. A relative byte address where the executed commit of the transaction (316B) is stored is written to the area (318B) of the log (317). A timestamp as the execution time of the executed commit of the transaction (316B) is written to the area (319B) of the log (317). Processing information of the executed commit of the transaction (316B) is written to the area (320B) of the log (317). The processing information is, for example, an SQL statement corresponding to the commit of the transaction (316B) or confirmed data corresponding to the commit of the transaction (316B).

FIG. 3E shows how data is reflected to update a database in the alternate system according to an embodiment of the present invention.

Updates committed at the quiesce point or later are stored in the message queue (310). The alternate system (305) obtains an update from the message queue (310) after the restoration of the database, and starts an operation of reflecting the update (314). Upon the operation of reflecting the update (314) obtained from the message queue (310), the alternate system (305) reads the quiesce point, and the timestamp or relative byte address regarding the quiesce point from the log taken from the queue or data set corresponding to the backup data. Further, the alternate system (305) reads information that is associated with the update and can identify the quiesce point from the log included in the update and taken from the queue. The alternate system (305) selects a desired update using the read information that is associated with the update and can identify the quiesce point, and timestamp or relative byte address regarding the quiesce point so as to reflect the update committed at the quiesce point or later thereon to reflect the update to the database restored in the alternate system (301). The reflecting operation is described below.

The production system (301) may select an update. If the production system (301) selects an update in place of the alternate system (305), the production system (301) does not start transmission of the update as illustrated in FIG. 3B but selects an update using the timestamp or relative byte address regarding the quiesce point so as to reflect the update committed at the quiesce point or later to transmit the selected update to the alternate system (305) after the determination of the quiesce point as illustrated in FIG. 3C. The alternate system (305) reflects all of the transmitted updates on the database restored in the alternate system (305).

Further, the production system continues operating as well as transmitting updates (312).

By reflecting an update made through the queue replication in sync with the operation of obtaining backup data at the quiesce point with the backup utility as above, an administrator can switch the production system to the alternate system without substantially stopping the transaction processing.

FIG. 3F shows an example where an update committed at a quiesce point or later is selected and reflected according to an embodiment of the present invention.

The production system writes data to the log where the information to be queued is written and transmits an update made through the queue replication at every updating operation. The update of the database is committed on a transaction basis at the time when the commit of the transaction is executed. When the system backs up or restores a database based on the quiesce point, updates corresponding to transactions already committed before the quiesce point are effective. Further, updates corresponding to transactions uncommitted at the quiesce point are rolled back, and the data are restored to the original (unupdated) one. In the embodiment of the present invention, at the time of reflecting an update made through the queue replication, a transaction committed at the quiesce point or later is selected and a corresponding update is reflected to thereby reflect an update in sync with backup. Further, updates corresponding to transactions started at the quiesce point or later are reflected without preconditions.

The arrows (322A to 324A, 322B to 324B, and 322C to 324C) in FIG. 3F indicate a transaction. A starting point (left side) of the arrow indicates the start of the transaction, and the endpoint (right side) of the arrow indicates the termination of the transaction. The triangle under the arrow indicates processing in the transaction. The processing includes an updating operation and commit of the transaction. The triangle under the endpoint of the arrow indicates the commit of the transaction, and the other triangles indicate the updating operation.

The transactions (322A to 324A) are illustrated as an example of a transaction accepted with the production system. The transaction (322A) is illustrated as an example where queue replication is started during the transaction processing in the production system. As for the transaction (322A), commit of the transaction is completed before the operation of obtaining backup data at the quiesce point. As for the transaction (322A), processing to be executed before the start of the queue replication is not included in the message queue, so the queue stores only partial information as indicated by the transaction (322B). As for the transaction (322A), the transaction is committed before the quiesce point upon the operation of obtaining backup data, so the queue stores information of all transactions as indicated by the transaction (322C). The alternate system compares a timestamp of the quiesce point with a timestamp of the commit of the transaction, for example. Alternatively, the production system may compare a timestamp of the quiesce point with a timestamp of the commit of the transaction, for example. In the transaction (322B), the timestamp of the commit of the transaction indicates an earlier time than the timestamp of the quiesce point. Thus, the transaction (322A) is considered to be committed before the quiesce point. As an alternative, the alternate system compares a relative byte address regarding the quiesce point with a relative byte address regarding the commit of the transaction. Alternatively, the production system may compare a relative byte address regarding the quiesce point with a relative byte address regarding the commit of the transaction. In the transaction (322B), an address indicated by the relative byte address regarding the commit of the transaction precedes an address indicated by the relative byte address regarding the quiesce point. Thus, the transaction (322A) is considered to be committed before the quiesce point. Therefore, in the transaction (322A), data in the message queue is not reflected in the alternate system and the original data is restored from the backup data.

The transaction (323A) is illustrated as an example where an operation of obtaining backup data is executed at the quiesce point during the transaction processing in the production system. As for the transaction (323A), the message queue stores information of all transactions as indicated by the transaction (323B). As for the transaction (323A), the transaction is committed after the quiesce point upon the operation of obtaining backup data, so the queue only stores information of transactions executed before the quiesce point as indicated by the transaction (323C), and its data is not restored. The alternate system compares, for example, a timestamp of the quiesce point with a timestamp of the commit of the transaction. Alternatively, production system may compare a timestamp of the quiesce point with a timestamp of the commit of the transaction in a similar manner. In the transaction (323B), the timestamp of the commit of the transaction indicates a later time than the timestamp of the quiesce point. Thus, the transaction (323A) is considered to be committed at the quiesce point or later. As an alternative, the alternate system compares a relative byte address regarding the quiesce point with a relative byte address regarding the commit of the transaction. Alternatively, the production system may compare a relative byte address regarding the quiesce point with a relative byte address regarding the commit of the transaction in a similar manner. In the transaction (323B), an address indicated by the relative byte address regarding the quiesce point precedes an address indicated by the relative byte address regarding the commit of the transaction. Therefore, the transaction (323A) is considered to be committed at the quiesce point or later. Thus, in the transaction (323A), data is not restored from the backup data in the alternate system but is restored by reflecting data in the message queue thereon.

The transaction (324A) is illustrated as an example where transaction processing is started in the production system after the operation of obtaining backup data at the quiesce point. As for the transaction (324A), the message queue stores information of the entire transaction as indicated by the transaction (324B). As for the transaction (324A), since the transaction is started after the quiesce point upon the operation of obtaining backup data, the queue stores no information of the transaction as indicated by the transaction (324C), and its data is not restored. The alternate system compares, for example, a timestamp of the quiesce point with a timestamp of the commit of the transaction. Alternatively, the production system may compare a timestamp of the quiesce point with a timestamp of the commit of the transaction in a similar manner. In the transaction (324B), the timestamp of the commit of the transaction indicates a later time than the timestamp of the quiesce point. Thus, the transaction (324A) is considered to be committed at the quiesce point or later. As an alternative, the alternate system compares a relative byte address regarding the quiesce point with a relative byte address regarding the commit of the transaction. Alternatively, the production system may compare a relative byte address regarding the quiesce point with a relative byte address regarding the commit of the transaction in a similar manner. In the transaction (324B), an address indicated by the relative byte address regarding the quiesce point precedes an address indicated by the relative byte address regarding the commit of the transaction. Thus, the transaction (324A) is considered to be committed at the quiesce point or later. Therefore, in the transaction (324A), data is not restored from the backup data in the alternate system but restored by reflecting data in the message queue thereon.

To be specific, the alternate system restores data (325) that is already committed at the quiesce point from the backup data of the database. Further, the alternate system selects an update corresponding to a transaction (326) that is committed at the quiesce point or later from updates made through the queue replication to reflect the update. Alternatively, the production system may select a transaction (326) that is committed at the quiesce point or later from updates made through the queue replication to reflect the update in a similar manner. With this method, the alternate system can restore the database with data consistency.

FIG. 3G shows how to switch the production system to the alternate system according to an embodiment of the present invention.

At the time when the operation of reflecting an update (314) proceeds on the alternate system (305) side and almost all updates are deleted from the message queue (310), the accepting queue (309) stops transmission of a transaction (327) to the production system (301) side. The accepting queue (309) starts transmission of a transaction (328) to the alternate system (305) side only after the transaction processing is completed on the production system (301) side and the operation of reflecting an update (314) is completed. In this example, the accepting queue (309) has a function of monitoring the number of transactions and the number of updates stored in the message queue. The monitoring function is given by the monitoring unit, and the monitoring unit may be included in any system. During the switchover to the alternate system (305), the production system (301) and the alternate system (305) halt for several seconds under normal conditions. During the suspension time, the processing accepting queue (309) queues the transactions (311). Owing to the queuing operation, it looks to a user like the service is provided without suspension.

FIG. 3H shows how to halt the production system according to an embodiment of the present invention.

An administrator halts the production system (301) for required maintenance. The processing accepting queue (309) transmits the queued transactions and new transactions to the alternate system (305). The alternate system (305) processes the queued transactions and new transactions in order. The processing result is reflected on the database (308).

Here, the maintenance work includes, for example, replacement of hardware and version upgrade of software in the production system.

An administrator can switch the alternate system (305) back to the production system (301) after the maintenance of the production system (301). The switchback can be executed by applying the procedure for switching the production system (301) to the alternate system (305) to a procedure for switching the alternate system (305) to the production system (301).

The switchback is schematically described below.

1. The alternate system starts transmission of updates to the message queue through the queue replication. The updates include an update and a log where the information to be queued is written.

2. The alternate system obtains backup data of a database by using the backup utility. The alternate system registers a quiesce point at which the backup data is obtained in the log where the information to be queued is written, together with a timestamp regarding the quiesce point or a relative byte address regarding the quiesce point. The registration is alternatively performed on a data set managed with the database management system (DBMS). The data may be included in the backup data. The quiesce point, and the timestamp regarding the quiesce point or relative byte address regarding the quiesce point are determined by executing, for example, a log suspend command or a backup system utility, and the alternate system can obtain the determined quiesce point and the determined timestamp or relative byte address regarding the quiesce point.

3. The production system restores a database from the backup data by using the restoring utility. The production system starts receiving the updates from the message queue. The production system obtains information that can identify a quiesce point for the backup of the database from the log or the data set corresponding to the backup data. The production system further obtains the information to be queued from the log. The production system reflects an update corresponding to a transaction committed at the quiesce point or later on the database of the production system using the information that can identify a quiesce point for the backup of the database and the information to be queued.

The alternate system may select an update. In the case where the alternate system selects an update in place of the production system, the alternate system does not start transmission of the update in above item 1. In above item 2, after the quiesce point is determined, an update is selected using the timestamp or relative byte address regarding the quiesce point so as to reflect an update corresponding to a transaction committed at the quiesce point or later, and the selected one is transmitted to the production system. The production system reflects all of the transmitted updates on the database restored in the production system.

4. At the time when an operation of reflecting an update proceeds in the alternate system and almost all updates are deleted from the message queue, the accepting queue as a monitoring unit stops transmission of a transaction to the alternate system. The accepting queue starts transmission of a transaction to the production system only after the transaction processing is completed in the alternate system and the operation of reflecting an update is completed.

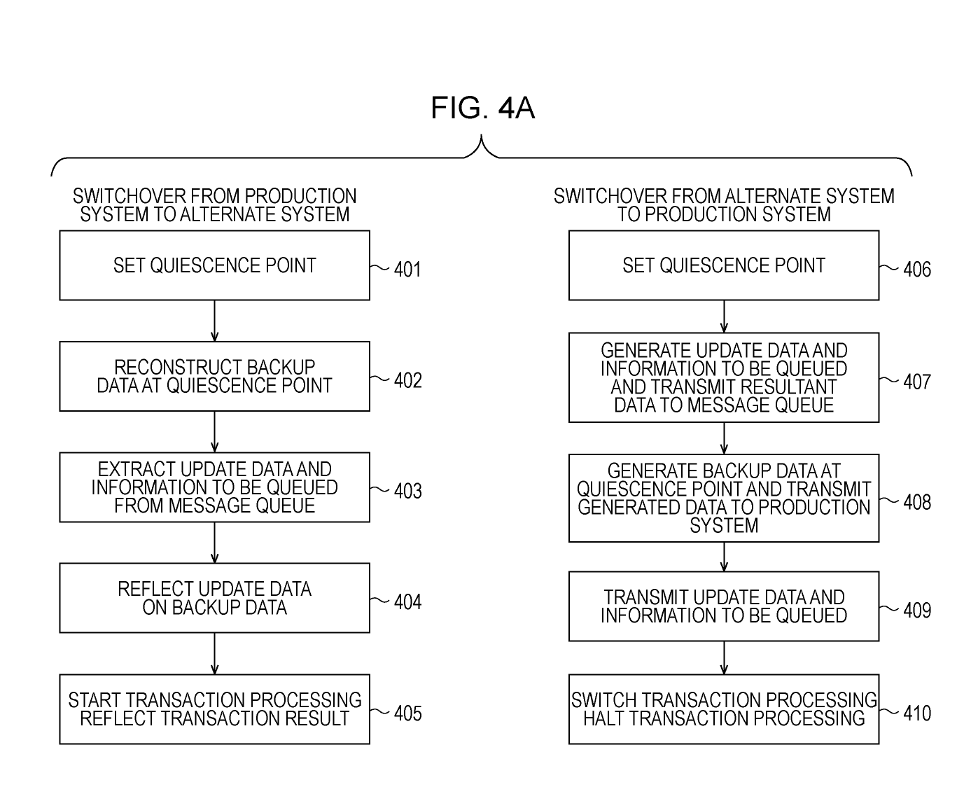

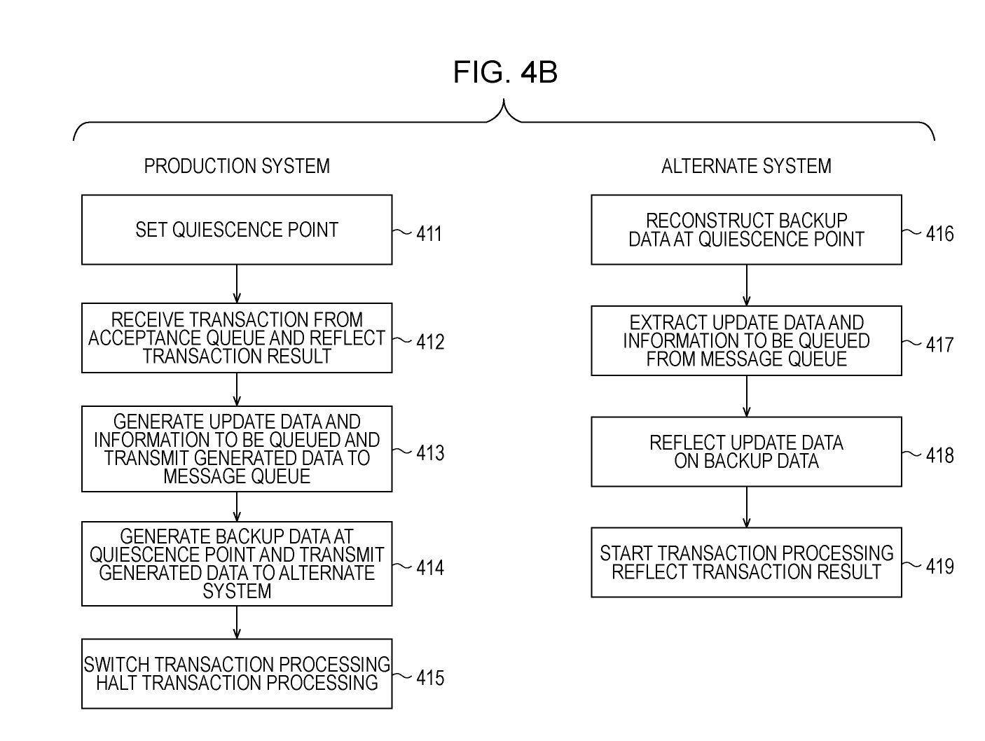

FIG. 4A is a flowchart of processing for switching a system on the alternate system side according to an embodiment of the present invention.

### 1. Switchover From Production System to Alternate System

An administrator of the system switches the production system to the alternate system for maintenance of the production system. The administrator of the system presets one or both of the quiesce point and the start time of transmission of the update and information to be queued to the message queue. The settings are made by the utility that provides a function of obtaining backup data, for example. If the administrator of the system sets the quiesce point or the start time, the alternate system sets the remaining one, the quiesce point or the start time (step S401).

The alternate system extracts, from the storage unit of the production system, which stores data including at least one update corresponding to a transaction processed by the production system, the data including at least one update at the last time the transaction was committed before the quiesce point, and then restores the obtained data to the storage unit of the alternate system. Here, the data refers to backup data generated using the backup utility at the quiesce point. The alternate system executes the extraction and the restoration using the restoring utility (step S402).

After the completion of the restoration, the alternate system accesses the message queue to start receiving the update and the information to be queued. The alternate system selects every update corresponding to the transaction committed at the quiesce point or later. Upon the selection, the alternate system uses information that can identify the quiesce point, in the information to be queued, the quiesce point, and the timestamp or relative byte address regarding the quiesce point. The alternate system obtains the selected update. The alternate system deletes the update and the information to be queued from the message queue. Here, the production system may select the update in place of the alternate system. If the production system selects the update, the production system performs the selection using the information that can identify the quiesce point, in the information to be queued, the quiesce point, and the timestamp or relative byte address regarding the quiesce point. The alternate system receives the update selected with the production system. The alternate system deletes the update and the information to be queued from the message queue (step S403).

The alternate system reflects the received selected update to the restored backup data (step S404).

After the update was completely reflected, the alternate system starts receiving the transactions from the accepting queue. The alternate system starts the transaction processing. The system, which monitors the message queue, the production system, and the alternate system, instructs the alternate system to start the operation of receiving the transaction and the transaction processing. The transaction result is reflected on the backup data on which the received selected update has been reflected (step S405).

### 2. Switchover From Alternate System to Production System

After the completion of maintenance of the production system, an administrator of the system switches the alternate system to the production system. The administrator of the system presets one or both of the quiesce point and the start time of transmission of an update and information to be queued to the message queue. The settings are made on a utility that provides a function of obtaining backup data, for example. If the administrator of the system sets the quiesce point or the start time, the alternate system sets the remaining one, the quiesce point or the start time (step S406).

The alternate system starts generating an update and information to be queued. The alternate system sends the update and the information to the message queue each time these are generated (step S407).

The alternate system obtains, from the storage unit of the alternate system, which stores at least one update regarding a transaction processed by the alternate system, backup data as data including the at least one update at the last time the transaction was committed before the quiesce point based on the backup utility. The alternate system transmits the backup data to the production system. The transmission is performed by using the restoring utility executed in the production system. The alternate system registers the quiesce point, and the timestamp or relative byte address regarding the quiesce point to the information to be queued at the time of generating the backup data. The information to be queued is transmitted to the message queue (step S408).

After the completion of the restoration, the production system accesses the message queue to start receiving an update and information to be queued. The production system selects an update corresponding to a transaction committed at the quiesce point or later. The production system performs the selection using the information that can identify the quiesce point, in the information to be queued, the quiesce point, and the timestamp or relative byte address regarding the quiesce point. The production system obtains the selected update. The production system deletes the update and the information to be queued from the message queue. Here, the alternate system may select the update in place of the production system. In the case of selecting the update, the alternate system performs the selection using the information that can identify the quiesce point, in the information to be queued, the quiesce point, and the timestamp or relative byte address regarding the quiesce point. The production system obtains the update selected with the alternate system. The production system deletes the update and the information to be queued from the message queue (step S409).

If the production system becomes ready for operation, the alternate system stops receiving a transaction. The system, which monitors the message queue, the production system, and the alternate system, instructs the alternate system to stop receiving a transaction. The transaction is transmitted to the production system instead (step S410).

FIG. 4B is a flowchart of processing executed in each of the production system and the alternate system according to an embodiment of the present invention.

An administrator of the system switches the production system to the alternate system for maintenance of the production system. The administrator of the system presets one or both of the quiesce point and the start time of transmission of an update and information to be queued to the message queue. If the administrator of the system sets only one of the quiesce point and the start time, the production system sets the remaining one, the quiesce point or the start time (step S411).

The production system receives a transaction from the accepting queue. The transaction is processed by the production system and the processing result is reflected on data stored in the storage unit of the production system (step S412).

The production system starts generation of the update and the information to be queued. The production system transmits the update and the information to the message queue each time these are generated (step S413).

The production system obtains, from the storage unit of the production system, which stores at least one update regarding a transaction processed by the production system, backup data as data including the at least one update at the last time the transaction was committed before the quiesce point based on the backup utility. The production system transmits the backup data to the alternate system. The transmission is performed by using the restoring utility executed in the alternate system. The production system registers the quiesce point, and the timestamp or relative byte address regarding the quiesce point to the information to be queued at the time of generating the backup data. The production system transmits the information to be queued to the message queue (step S414).

If the alternate system becomes ready for operation, the production system stops receiving the transaction. The system, which monitors the message queue, the production system, and the alternate system, instructs the production system to stop receiving a transaction. The transmission of transaction is switched to the alternate system (step S415).

The alternate system obtains the backup data of the production system generated in step S414 and restores the obtained data to the storage unit of the alternate system (step S416).

After the completion of the restoration, the alternate system accesses the message queue to start receiving the update and information to be queued. The alternate system selects an update corresponding to the transaction committed at the quiesce point or later. The alternate system performs the selection using the information that can identify the quiesce point, in the information to be queued, the quiesce point, and the timestamp or relative byte address regarding the quiesce point. The alternate system receives the selected update. The alternate system deletes the update and the information to be queued from the message queue (step S417). The production system may receive these in place of the alternate system. In the case of receiving these, the production system accesses the message queue after the completion of the restoration to start receiving the update and information to be queued. The production system selects an update corresponding to the transaction committed at the quiesce point or later. The production system performs the selection using the information that can identify the quiesce point, in the information to be queued, the quiesce point, and the timestamp or relative byte address regarding the quiesce point. The production system receives the selected update. The production system deletes the update and the information to be queued from the message queue.

The alternate system reflects the received selected update to the restored backup data (step S418).

After all of the updates were completely reflected thereon, the alternate system starts receiving a transaction from the accepting queue. The alternate system starts transaction processing. The system, which monitors the message queue, the production system, and the alternate system, instructs the alternate system to start the operation of receiving the transaction and the transaction processing. The transaction result is reflected on the backup data on which the received selected update has been reflected (step S419).

The production system and the alternate system of an embodiment of the present invention each include a CPU and a main memory, which are connected to a bus. The CPU is preferably based on 32-bit or 64-bit architecture. The bus is connected to a display such as an LCD monitor through a display controller. The display is used to display information about a computer connected to a network through a communication line for managing a computer system and information about software running on the computer with an appropriate graphic interface. The bus is also connected to a hard disk or silicon disk and a CD-ROM, a DVD, or other optical drive through an IDE or SATA controller.

The hard disk stores an operating system, database management software, and other such programs and data in the form of being loadable to a main memory.

A CD-ROM, DVD, or BD drive is optionally used to additionally install programs from a CD-ROM, a DVD-ROM, or a BD to a hard disk. The bus is further connected to a keyboard and a mouse through a keyboard/mouse controller.

A communication interface conforms to, for example, the Ethernet (trademark) protocol, and is connected to the bus through a communication controller. The interface serves to physically connect a computer and a communication line, and provides a network interface layer to a TCP/IP communication protocol for a communication function of an operating system of the computer. The communication line may be used in wired LAN environments or wireless LAN environments conforming to wireless LAN connection standards, for example, IEEE 802.11a/b/g/n.

Further, conceivable examples of a network connection device for connecting hardware such as a computer include a router and a hardware management console in addition to the network switch, although these are illustrative only. In other words, a usable device has a function capable of sending, in response to an inquiry included in a predetermined command from a computer having a network operation management program installed thereto, configuration information such as an IP address or a MAC address of the computer, which is connected thereto. The network switch and the router have an ARP table storing a list of IP addresses of a connected computer and corresponding MAC addresses, for an address resolution protocol (ARP), and have a function of sending data in the ARP table in response to an inquiry included in a predetermined command. The hardware management console can send back more detailed information, that is, computer configuration information, than the data in the ARP table.

While the present invention has been described with respect to various embodiments thereof, it is not limited to the scope described above with respect to these embodiments. It is, therefore, to be understood that various changes and medications of the above-described embodiments will readily occur to those skilled in the art. It is apparent from the description in the appended claims that other embodiments of the invention provided by making such changes and modifications are also included in the technical scope of the present invention.

1. An alternate system that is a backup system of a production system for processing transactions, comprising:
a restoring unit for obtaining, from a storage unit of the production system that stores data including at least one update regarding a transaction processed with the production system, data including the at least one update at a last time the transaction was committed before a quiesce point, to copy the obtained data to a storage unit in the alternate system;
a copying unit for copying an update that is selected from a message queue that stores the update and information that is associated with each update and that can identify the quiesce point, using the information that can identify the quiesce point, and committed at the quiesce point or later, to the storage unit of the alternate system; and
a transaction processing unit for taking at least one transaction from an accepting queue that accepts transaction processing requests upon completion of copying the selected update to start processing of the taken transaction.

2. The alternate system according to claim 1, wherein the information that can identify the quiesce point is a timestamp related to the commit of the transaction or a relative byte address related to the commit of the transaction.

3. The alternate system according to claim 1, wherein the data stored on the message queue includes an update and a timestamp related to the commit of the transaction of the update or a relative byte address related to the commit of the transaction of the update.

4. The alternate system according to claim 1, wherein the information that can identify the quiesce point is obtained by executing a log suspend command.

5. The alternate system according to claim 1, wherein at the start of processing for acquiring the transaction, confirming completion of processing regarding the transaction transferred from the accepting queue to the production system.

6. The alternate system according to claim 1, wherein the storage unit of the alternate system further stores data including at least one update regarding a transaction processed with the transaction processing unit of the alternate system.

7. The alternate system according to claim 1, further comprising:
a transmitting unit for transmitting to the production system, the data including the at least one update of the alternate system, from the storage unit of the alternate system, which stores an update regarding a transaction of the alternate system, at the last time the transaction was committed just before the quiesce point.

8. The alternate system according to claim 6, further comprising:
a transmitting unit for transmitting to the message queue, at least one update regarding a transaction processed with the transaction processing unit of the alternate system, and information that is associated with each update and can identify the quiesce point.

9. A production-alternate system, comprising:
a production system for processing transactions;
an alternate system that is a backup system of the production system; and
an accepting queue for accepting a transaction, which is connectable to the production system or the alternate system,
the production system including:
a transaction processing unit for taking a transaction from the accepting queue to process the taken transaction;
a storage unit for storing data including at least one update regarding a transaction processed with the production system;
a first transmitting unit for transmitting to a message queue, the update and information that is associated with each update and that can identify a quiesce point; and
a second transmitting unit for transmitting to the alternate system, the data including the at least one update, at the last time the transaction was committed before the quiesce point,
the alternate system including:
a storage unit for receiving the data including the at least one update sent from the production system to store the received data;
a copying unit for copying an update that is selected using the information that can identify the quiesce point and is committed at the quiesce point or later, from the message queue to the storage unit of the alternate system; and
a transaction processing unit for taking at last one transaction from an accepting queue that accepts transaction processing request upon completion of copying the selected update to start processing of the taken transaction.

10. A method for switching transaction processing between a production system for processing transactions and an alternate system as a backup system of the production system, comprising:
obtaining, from a storage unit of the production system, which stores data including at least one update regarding a transaction processed with the production system, data including the at least one update, at the last time the transaction was committed before a quiesce point, to copy the obtained data to a storage unit of the alternate system;
copying, from a message queue that stores the update and information that is associated with each update and can identify the quiesce point, an update that is selected using the information that can identify the quiesce point and is committed at the quiesce point or later to the storage unit of the alternate system; and
taking at least one transaction from an accepting queue that accepts processing request of the transaction upon completion of copying the selected update to start processing of the taken transaction.

11. The method according to claim 10, further comprising:
storing at least one update regarding a transaction processed with the alternate system in the storage unit of the alternate system.

12. The method according to claim 11, further comprising:
storing in a message queue associated with the alternate system, at least one update regarding a transaction processed with the alternate system and information that is associated with each update and that can identify the quiesce point, in response to a command to switch the alternate system to the production system.

13. The method according to claim 12, further comprising:
transmitting the data including the at least one update at the last time the transaction was committed before the quiesce point, from the storage unit of the alternate system to the production system.

14. The method according to claim 13, further comprising:
transmitting an update selected using information that can identify the quiesce point and committed at the quiesce point or later, from a message queue associated with the alternate system to the production system.

15. The method according to claim 14, further comprising:
switching transaction processing from the alternate system to the production system after all of the selected update is transmitted to the production system.
